(19) United States
(12) Patent Application Publication
(10) Pub. No.: US 2005/0230986 A1
(43) Pub. Date: Oct. 20, 2005

(54) Apparatus for manipulating landscaping and other similar materials

(76) Inventor: Paul A. Lindberg, Charlevoix, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/826,073

(22) Filed: Apr. 16, 2004

(51) Int. Cl. B66C 1/28

(52) U.S. Cl. 294/118

(57) ABSTRACT

A device for lifting and otherwise manipulating large landscaping materials and other like objects. The lifting device generally includes a pair of arms pivotally interconnected to one another at a pivot joint, a separate shackle mounted to the upper end of each arm and a lift ring interconnected with the shackles. The lifting device may include laterally extending jaws affixed to the lower end of each arm. The arms may be generally “S”-shaped having a lower portion curving about a center on the interior side of the arm and an upper portion curving about a center on the exterior side of the arm.

### BACKGROUND OF THE INVENTION

The present invention relates to landscaping, and more particularly a device for lifting and placing large landscaping objects and other similar materials.

There are a wide variety of large, heavy objects used in landscaping and other similar environments. These objects include things such as large rocks, bricks, shaped stone and trees with large root balls. When working with these types of objects, for example, in landscaping, water breakwalls and other similar applications, it is conventional to use straps, ropes, chains or other similar devices to lift and move the objects. Straps provide only limited control over the item and can be difficult to properly position in many cases. For example, it can be difficult to positions straps or chains when they need to run beneath the object. In such applications, it may be necessary to tilt the object to provide clearance for the straps or chains. Also, if the straps or chains are not properly positioned or the object is of the wrong shape (e.g. a sphere), the object may slip from the straps or chains during manipulation. Further, straps or chains can be trapped under the object when it is lowered into the desired position. This may make it necessary to tilt or otherwise partially lift the object to free the straps or chains.

In other applications, objects are moved using the bucket of a front end loader, backhoe or other similar construction machinery. Unfortunately, this type of machinery requires the object to be slid or scooped up into the bucket, which may be difficult and may damage the object. This can be particular difficult when objects are randomly stacked or located on uneven terrain. Further, the object must be slid or dropped into place from the bucket. This makes precise placement of an object difficult and may result in damage to the object. Accordingly, there is a continuing need for a device capable of facilitating the manipulation of large objects of the type described above.

### SUMMARY OF THE INVENTION

The aforementioned problems are overcome by the present invention which provides tongs configured to manipulate rocks, boulders and other large materials. In one embodiment, the apparatus includes tongs having a pair of pivotally-joined arms, each shackled to a lift ring at one end and terminating in a laterally extending jaw at the other. The jaws may include a plurality of protrusions that permit the tongs to securely grip a wide variety of items, including inflexible items, such as large landscaping rocks.

The arms are pivotally joined together with the pivot dividing each arm into upper and lower arm segments. In one embodiment, the upper arm segment of each arm is curved upwardly toward the shackle to permit the arms to open fully without interference from the lift ring.

In another embodiment, the arms are configured with an offset pivot location that places the jaws and shackles in vertical alignment. The offset configuration reduces the tendency of the tongs to twist during use.

In yet another embodiment, the tongs include handles that permit an individual to easily rotate landscaping items, for example, to rotate landscaping rocks to the desired orientation.

The present invention provides a simple and effective apparatus for lifting rocks, boulders, landscaping materials and other similar items. The wide lateral jaws of the present invention permit the apparatus to grip a wide range of items, including large, uneven and hard items such as rocks. The curved upper arms permit the tongs to be fully opened to extend around large, bulky items. The jaws extend in a generally horizontal plane when fully opened and pivot upwardly as the tongs are closed. In this way, the weight of the item to be manipulated works to operate the tongs. Further, the offset pivot region permits the shackle and jaw ends of each of the arms to be in vertical alignment. Accordingly, the lifting action does not create a twisting force on the tongs.

These and other objects, advantages, and features of the invention will be readily understood and appreciated by reference to the detailed description of the preferred embodiment and the drawings.

### BRIEF DESCRIPTION OF THE DRAWINGS

FIG. 1A is a perspective view of the apparatus in accordance with a preferred embodiment in the fully open position.

FIG. 1B is a perspective view of the apparatus in a partially closed position.

FIG. 2 is a front elevational view of the apparatus.

FIG. 3 is a right side elevational view of the apparatus.

FIG. 4 is a top plan view of the apparatus with the shackles and lift ring removed.

FIG. 5 is a front elevational view of an arm of the present invention.

FIG. 6 is a top plan view of an arm of the present invention.

FIG. 7 is a top plan view of a jaw of the present invention.

FIG. 8 is a side elevational view of the jaw.

### DETAILED DESCRIPTION OF THE PREFERRED EMBODIMENT

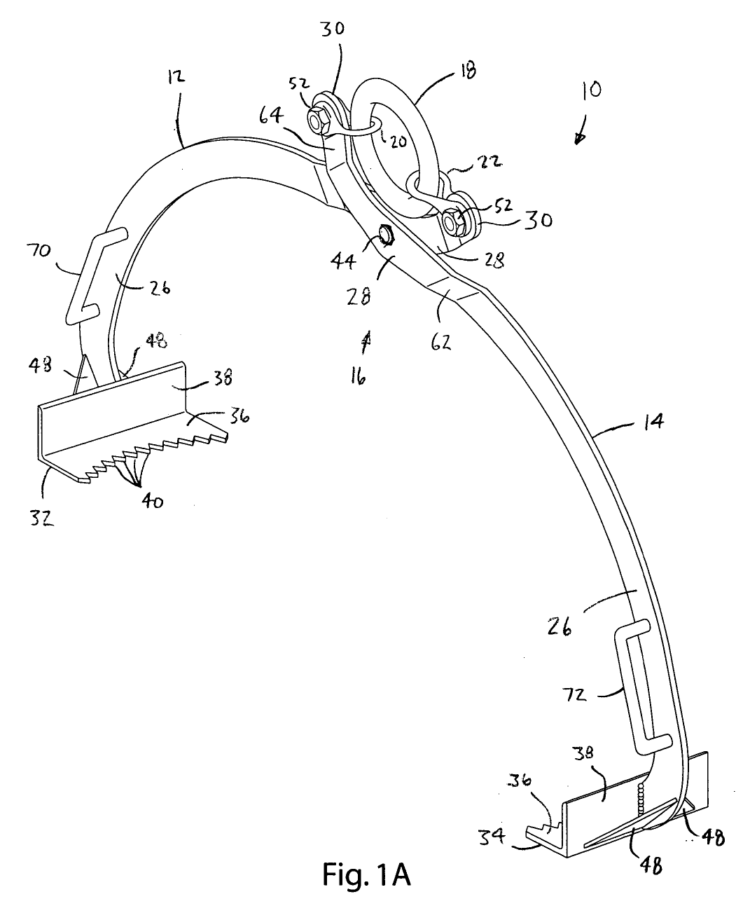

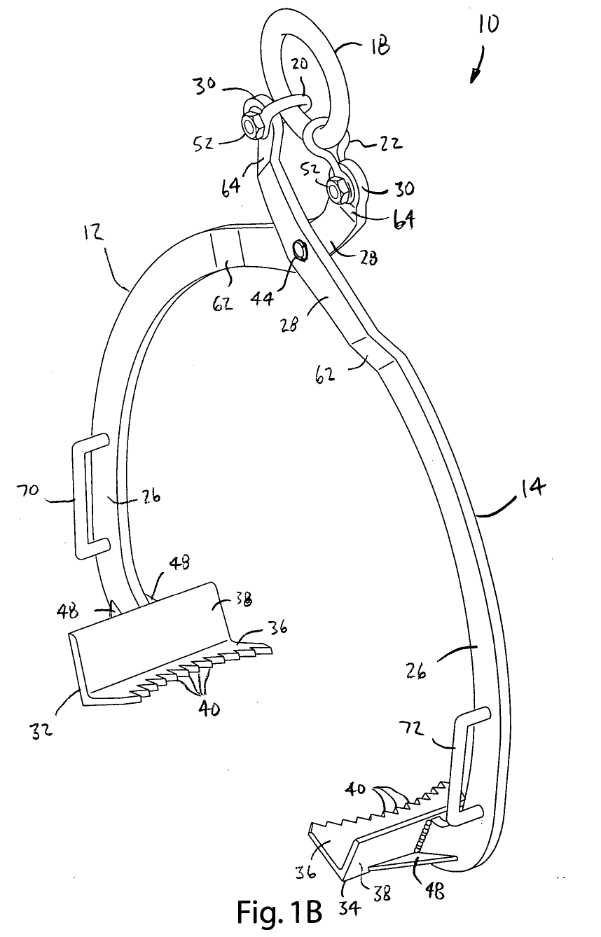

An apparatus for manipulating landscaping and other similar items is shown in FIG. 1, and generally designated 10. The illustrated apparatus 10 is intended for use in lifting a wide variety of large landscaping items, such as landscaping rocks. The apparatus 10 generally includes two arms 12 and 14 that are pivotally interconnected to form tongs 16. The two arms 12 and 14 are coupled to a lift ring 18 by a pair of shackles 20 and 22. The lift ring 18 can be connected, for example, using a cable or chain, to a lifting device, such as to a crane, a fork lift or to the bucket of a front end loader or back hoe. In use, the lifting device (e.g. a front end loader) lifts the lift ring 18, thereby causing the shackles 20 and 22 to move together as they are drawn down the lift ring 18. This draws the arms 12 and 14 together in a scissoring action that closes them around the item to be lifted (compare FIGS. 1A and 1B). In this way, the weight of the object to be lifted actually helps to close the arms 12 and 14.

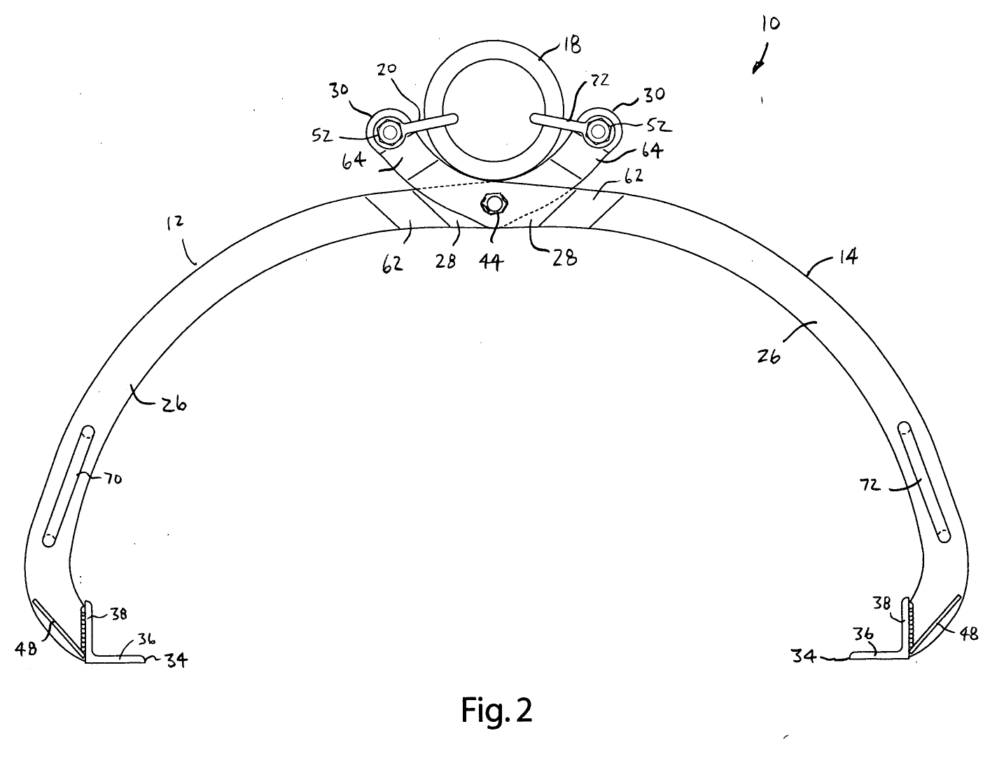

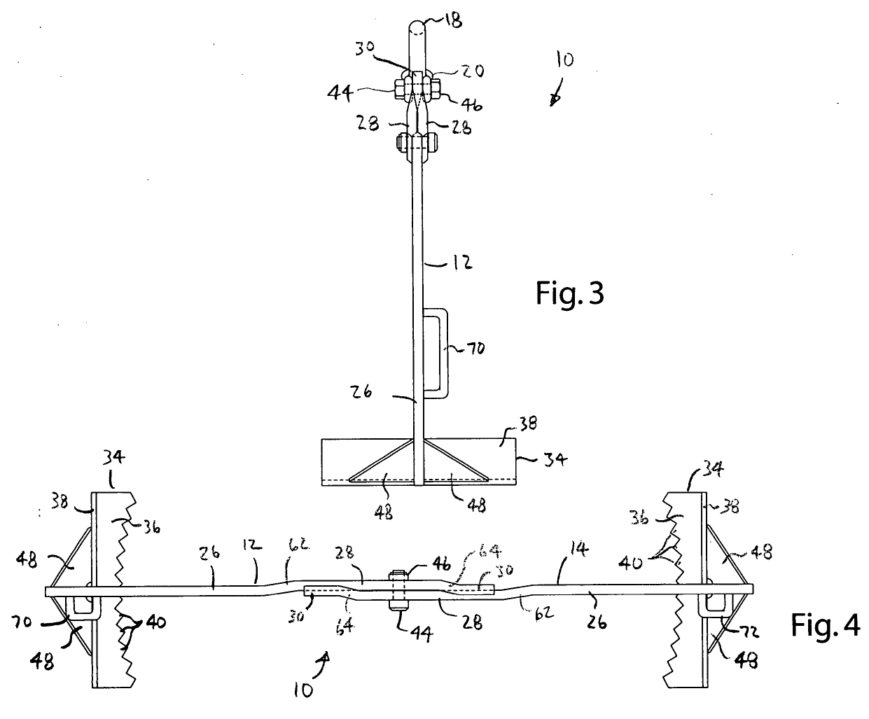

Referring now to the illustrated embodiment, the apparatus 10 may include two essentially identical arms 12 and 14. Each arm 12, 14 generally includes a lower jaw portion 26, a central pivot portion 28 and an upper shackle portion 30. The lower jaw portion 26 follows a relatively dramatic arc throughout most of its length. This arc is selected to provide jaws that can open wide to receive large bulky items that approach a rectangular shape. In one embodiment, a majority of the lower jaw portion 26 has an inner edge that follows a radius of approximately 21 27/32 inches and an outer edge that follows a radius of curvature of approximately 24 1/8 inches, with both radii of curvature having a common center disposed on the interior side of the arm 12, 14. More specifically, the center of this radius of curvature may be located at approximately 23 3/16 inches below and 3 15/32 inches offset from the center of the pin pivot hole 42 (described below) when the arms 12, 14 are in the fully open position (See FIG. 2). In this embodiment, the bottom section of the lower jaw portion 26 follows different radii of curvature than the majority described above. More specifically, the bottom section has an inner edge that follows a radius of approximately 4 3/8 inches that is centered approximately 20 23/32 inches below and 20 25/32 inches offset from the center of the pin pivot hole 42, and an outer edge that follows a radius of curvature of approximately 6 9/32 inches that is centered approximately 20 13/16 inches below and 21 17/32 inches offset from the center of the pin pivot hole when the arms 12, 14 are in the fully open position. In this embodiment, the arms 12, 14 are manufactured from 3/4 inch thick ASTM A-36 mild steel, but they can be manufactured from other materials.

A jaw 32, 34 is fixedly mounted to the lower jaw portion 26, for example, by welding. The jaws 32 extends laterally from the arm 12, 14 to define a relatively wide gripping surface. The jaws 32, 34 of the illustrated embodiment are each manufactured from a segment of angle iron. Each jaw 32, 34 includes a base 36 and a support 38 extending at approximately ninety degrees from one other (See FIGS. 7 and 8). The base 36 is configured to define a gripping surface, and preferably includes a series of teeth 40 disposed about a broad curve. In the illustrated embodiment, each jaw 32, 34 includes twelve teeth 40 orientated along a constant radius of curvature of approximately 23¾ inches at their base. In this embodiment, the jaws are manufactured from 3½ inch by 3½ inch by 3/8 inch angle ASTM A-36 mild steel, but they can be manufactured from other materials. The jaws 32, 34 are mounted to the arm 12, 14 so that the base 36 of each jaw 32, 34 is approximately horizontal and the support 38 is approximately vertical when the arms 12, 14 are fully opened (See FIGS. 1 and 2). As the arms 12, 14 close, the base 36 of each jaw 32, 34 pivots upwardly out of the horizontal plane. Each arm 12, 14 also includes a pair of reinforcing plates 48 that are mounted, for example, by welding, between the jaw 32, 34 and the lower portion 26. As shown, the reinforcing plates 48 may be generally rectangular in shape and may be mounted at an angle of approximately forty eight degrees from the plane of the base 36. In this embodiment, the reinforcing plates are manufactured from ¼ inch thick ASTM A-36 mild steel, but they can be manufactured from other materials.

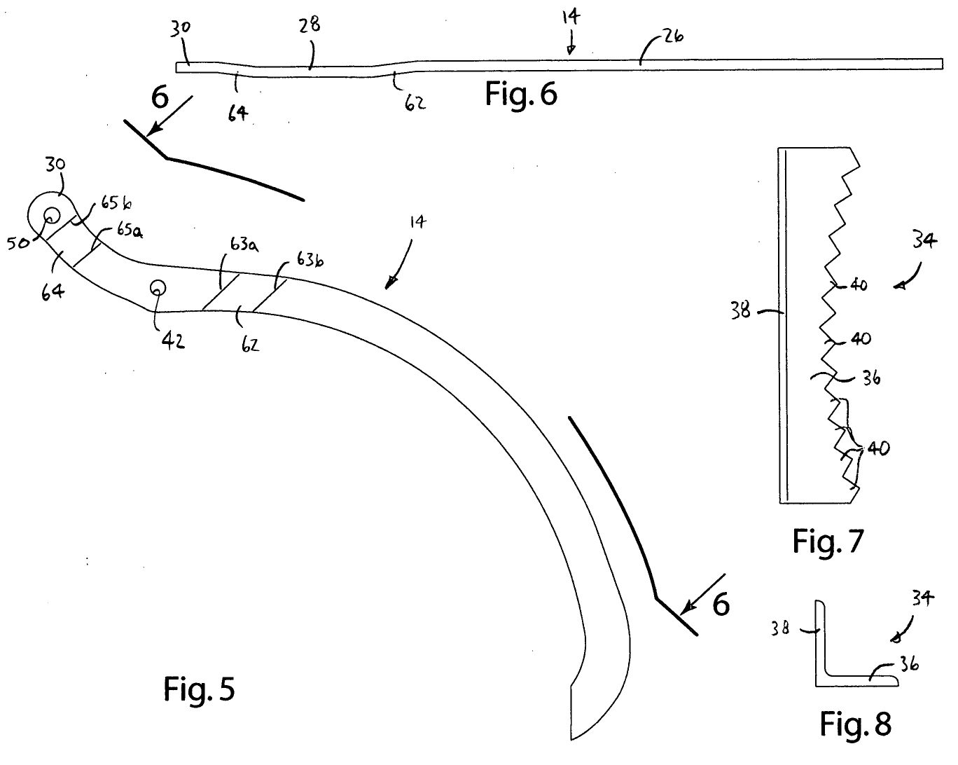

As noted above, each arm 12, 14 also includes a central pivot portion 28 at which the arms 12, 14 are pivotally interconnected. In the illustrated embodiment, the central pivot portion 28 is offset from the lower portion 26 and upper portion 30 by approximately one half of the thickness of the arms 12, 14 (See FIG. 4). As a result of this offset, the lower portions 26 and upper portions 30 of the two arms 12, 14 are in substantial vertical alignment despite the adjacent, overlapping relationship of the central pivot portions 28. The offset may be defined by a pair of transition segments 62, 64. In the illustrated embodiment, the lower transition segment 62 is defined by a pair of parallel bends 63a-b that are approximately 2⅛ inches apart (See FIG. 5). Each bend extends at an angle of approximately 10.1 degrees from the lower jaw portion 26. The distance from the center of the pivot pin hole 42 to the point of intersection of the closest bend 63a with the outer edge of the arm is approximately 5 3/16 inches in this embodiment. In the illustrated embodiment, the upper transition segment 64 is defined by a pair of parallel bends 65a-b that are, like the lower transition segment, approximately 2⅛ inches apart (See FIG. 5). Each bend 65a-b extends up (or down) at an angle of approximately 10.1 degrees from the lower jaw portion 26. The distance from the center of the pivot pin hole 42 to the point of intersection of the closest bend 65a with the inner edge of the arm is approximately 5 3/16 inches in this embodiment. The central pivot portion 28 of each arm 12, 14 defines a pivot pin hole 42 that pivotally receives the pivot pin 44. The pivot pin 44 pivotally interconnects the two arms 12, 14. The pivot pin 44 may include a threaded end and be secured in place within the pivot pin holes 42 by a nut 46. In the illustrated embodiment, the pivot pin 44 has a diameter of approximately 7/8 of an inch and is manufactured from hardened steel having a hardness of approximately Rockwell B-75. Although not shown, a bushing, bearing or other friction reducing element may be mounted within the pivot pin hole 42 to facilitate pivotal movement of the arms 12, 14. The central pivot portion 28 follows a compound curve. The lower end of the central pivot portion 28 follows approximately the same radius of curvature as the lower jaw portion 28 of the arm 12, 14. The upper end of the central pivot portion 28 follows a radius of curvature in the opposite direction. The radius of curvature of the upper end of the central pivot portion 28 is selected to provide sufficient clearance for the arms 12, 14 to open fully without pinching the lift ring 18. In the illustrated embodiment, the inside edge of the upper end follows a radius of curvature of approximately 10 11/32 inches centered at approximately 9 1/16 inches above and 1 3/4 inches offset from the pivot pin hole 42, and the outside edge follows a radius of curvature of approximately 5½ inches centered at approximately 6 31/32 inches above and 5/16 inches offset from the pivot pin hole 42 when the arms 12, 14 are in the fully open position.

The upper shackle portion 30 is configured to mount to shackles 20, 22. The upper shackle portion 30 extends from the central pivot portion 28 and is generally circular. Each upper shackle portion 20 defines a shackle pin opening 50 to receive a pin 52 for mounting the shackle 20, 22 to the arm 12, 14. The shackle pin 52 may include a threaded end and be secured in the shackle pin opening 50 by a nut.

The shackles 20, 22 interconnect the arms 12, 14 and the lift ring 18. The shackles 20, 22 are somewhat “U”-shaped defining an interior space to loosely receive the lift ring 18 and having a mouth that is pivotally affixed to the upper shackle portion 20. In the illustrated embodiment, opposite ends of each shackle 20, 22 define a shackle pin opening (not shown) to receive the corresponding shackle pin 52. As shown, the shackle pin 52 extends through the shackle pin opening at one end of the shackle 20, 22 then through the shackle pin opening in the upper shackle portion 20 and finally through the shackle pin opening 60 at the opposite end of the shackle 20, 22. As noted above, the shackle pin 52 may be secured by a nut 54.

As noted above, the lift ring 18 is operative connected to a device capable of lifting the object to be lifted, for example, by a rope, chain or strap. The lift ring 18 is a generally circular ring that passes through the internal space 56 defined by each of the shackles 20, 22. In the illustrated embodiment, the lift ring 18 has an inner diameter of approximately 6 inches and an outer diameter of approximately 8¼ inches. Although shown as a circular ring, the lift ring 18 may alternatively have other shapes, provided that it includes angled portions that cause the shackles 20, 22 to come together when the lift ring is lifted.

In the illustrated embodiment, each arm 12, 14 further includes a handle 70, 72 that helps to manipulate the apparatus 10 and in turn the lifted object (not shown) into the desired orientation. In this embodiment, each handle 70, 72 includes a generally u-shaped member that is welded or otherwise secured to the corresponding arm 12, 14. The shape of the handles may vary from application to application. The handles 70, 72 are preferably located toward the bottom of the arms 12, 14, where they have greater leverage and are more readily accessible, but they may be located at other locations along the arms 12, 14 or jaws 34.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A device for lifting/manipulating landscaping and other like materials, comprising:
a first arm having an upper portion, a pivot portion and a lower portion;
a second arm having an upper portion, a pivot portion and a lower portion, said pivot portion of said first arm pivotally connected to said pivot portion of said second arm;
wherein at least one of said pivot portion of said first arm and said pivot portion of said second arm is offset, whereby said upper portion and said lower portion of said first arm extend along a common plane with said upper portion and said lower portion of said second arm.

2. The device of claim 1 wherein at least a portion of said upper portion of said first arm follows a first radius of curvature having a center on an exterior side of said first arm.

3. The device of claim 2 wherein at least a portion of said lower portion of said first arm follows a second radius of curvature having a center on an interior side of said first arm.

4. The device of claim 3 wherein at least a portion of said upper portion of said second arm follows a third radius of curvature having a center on an exterior side of said second arm and at least a portion of said lower portion of said second arm follows a fourth radius of curvature having a center on an interior side of said second arm.

5. The device of claim 4 wherein said first arm is pivotally connected to said second arm by a pivot element; and
wherein said first arm transitions between said first radius of curvature and said second radius of curvature in approximate alignment with said pivot element.

6. The device of claim 1 further comprising a first jaw affixed to said first arm, said jaw extending substantially perpendicularly to a longitudinal extent of said first arm.

7. The device of claim 6 wherein said jaw includes a plurality of teeth.

8. The device of claim 7 wherein said plurality of teeth are oriented along a radius of curvature having a center on an interior side of said first arm.

9. The device of claim 8 wherein said jaw is manufactured from a segment of angle iron having a first leg and a second leg, said plurality of teeth being defined in said first leg.

10. The device of claim 9 wherein said arms of moveable between a first fully open position and a second closed position; and
wherein said jaw is mounted to said first arm such that said first leg of said first jaw extends along a substantially horizontal plane when said arms are in said first fully open position.

11. The device of claim 10 further comprising a pair of reinforcing plates interconnected between said first jaw and said first arm, said reinforcing plates being disposed on opposite sides of said first arm.

12. The device of claim 11 wherein said reinforcing plates extend between said second leg and said first arm.

13. The device of claim 1 further comprising a handle mounted to said first arm.

14. A device for lifting and manipulating landscaping and other like materials, comprising:
a first arm;
a second arm;
a pivot joint pivotally interconnecting said first arm and said second arm;
a lift ring;
a first shackle interconnecting said first arm to said lift ring; and
a second shackle interconnecting said second arm to said lift ring.

15. The device of claim 14 further comprising a first jaw affixed to said first arm, said first jaw extending substantially perpendicularly to a longitudinal extent of said first arm; and
a second jaw affixed to said second arm, said second jaw extending substantially perpendicularly to a longitudinal extent of said second arm.

16. The device of claim 15 wherein said jaw includes a plurality of teeth oriented along a curve.

17. The device of claim 16 wherein said jaw is manufactured from a segment of angle iron having a first leg and a second leg, said plurality of teeth being defined in said first leg.

18. The device of claim 17 wherein said arms of moveable between a first fully open position and a second closed position; and
wherein said first jaw and said second jaw are mounted to said first arm and said second arm such that said first leg of said first jaw and said first leg of said second jaw extend along a substantially horizontal plane when said arms are in said first fully open position.

19. The device of claim 14 wherein each of said first arm and said second arm are somewhat “S”-shaped having a lower portion extending along a radius of curvature opening inwardly and an upper portion extending along a radius of curvature opening outwardly.

20. The device of claim 19 further comprising a first handle mounted to said lower portion of said first arm and a second handle mounted to said lower portion of said second arm.

21. The device of claim 14 wherein said first arm includes an offset portion and second arm includes an offset portion; and
wherein said pivot joint includes a pivot pin interconnecting said offset portion of said first arm with said offset portion of said second arm.
